(19) United States
(12) Patent Application Publication
(10) Pub. No.: US 2013/0282952 A1
(43) Pub. Date: Oct. 24, 2013

(54) STORAGE SYSTEM, STORAGE MEDIUM, AND CACHE CONTROL METHOD

(71) Applicant: FUJITSU LIMITED, Kawasaki-shi (JP)

(72) Inventor: Takeshi MIYAMAE, Kawasaki (JP)

(73) Assignee: FUJITSU LIMITED, Kawasaki-shi (JP)

(21) Appl. No.: 13/845,412

(22) Filed: Mar. 18, 2013

(30) Foreign Application Priority Data
Apr. 18, 2012 (JP) 2012-094559

(51) Int. Cl. G06F 12/08; G06F 12/02

(52) U.S. Cl. CPC G06F 12/0884; G06F 12/0238
USPC 711/102; 711/120

(57) ABSTRACT

A storage system includes a storage that stores a file; and a plurality of access control devices that control access to the storage and include a cache memory in which the file is stored in blocks, wherein when receiving an update request of a prescribed block and latest data of the prescribed block is not stored in the cache memory of a first access control device, the first access control device among the plurality of access control devices obtains a version number added to the latest data from a second access control device, in which the latest data is stored, among the plurality of access control devices, and wherein the first access control device stores update data that updates the prescribed block in the cache memory of the first access control device and adds a new version number to the update data based on the version number.

### CROSS-REFERENCE TO RELATED APPLICATIONS

This application is based upon and claims the benefit of priority from the prior Japanese Patent Application No. 2012-094559 filed on Apr. 18, 2012, the entire contents of which are incorporated herein by reference.

### FIELD

The embodiments discussed herein are related to a storage system, a storage medium, and a cache control method.

### BACKGROUND

In recent years, a log-structured file system has attracted attention as a type of file system. According to the log-structured file system, when data of a block in which the file is divided is updated, the updated data is stored in a storage area that is different from the storage area where the data before the updated is stored, so that the data before the update is not overwritten. The above-described processing has an advantage that the data is prevented from being damaged due to an error occurring at time of updating the data or that a snap-shot may be taken.

There is a storage system in which dispersion cache is configured by dispersing and allocating cache areas in a plurality of servers. As for the dispersion cache, for example, processing of data reference or data update is controlled so that compliance of data among the cache areas is achieved.

There is an example of technique related to the dispersion cache. According to this technique, a file server stores version information of each block, and a plurality of clients having the cache area respectively is able to check a file server to inquire whether the data that is stored in the cash area of their own is latest.

For example, there is an example of a management method of a database by using a multi-version method for holding the data before and after the update.

However, in the system using the dispersion cache, the plurality of clients does not have a function for managing the number of versions of data to be stored in each cache area thereof. Accordingly, unlike the log-structured file system, the system using the dispersion cache may not leave the data every time the data is updated. For example, Japanese Laid-open Patent Publication No. 2011-204008, Japanese Laid-open Patent Publication No. 7-319750, and Japanese Laid-open Patent Publication No. 2002-278817 are disclosed as a Related art.

### SUMMARY

According to an aspect of the invention, a storage system includes a storage that stores a file; and a plurality of access control devices that control access to the storage and include a cache memory in which the file to be stored in the storage is stored in blocks, wherein when receiving an update request of a prescribed block and latest data of the prescribed block is not stored in the cache memory of a first access control device, the first access control device among the plurality of access control devices obtains a version number added to the latest data from a second access control device, in which the latest data is stored in the cache memory thereof, among the plurality of access control devices, and wherein the first access control device stores update data that updates the prescribed block in the cache memory of the first access control device and adds a new version number to the update data based on the version number.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration and an operation of a storage system according to a first embodiment;

FIG. 2 is a diagram illustrating an example of a whole configuration of a storage system according to a second embodiment;

FIG. 3 is a diagram illustrating an example of a hardware configuration of a frontend;

FIG. 4 is a block diagram illustrating an example of a configuration of a processing function of the frontend;

FIG. 5 is a diagram illustrating an example of cache control using an internal cache and an off-core cache;

FIG. 6 is a diagram illustrating an example of a database configuration for file management by a file management unit;

FIG. 7 is a flowchart illustrating an example of a processing procedure of the file management unit when a status is “Modified”;

FIG. 8 is a flowchart illustrating an example of the processing procedure of the file management unit when the status is “Shared”;

FIG. 9 is a sequence diagram illustrating an example of processing when the status of the frontend that performs the update is “Shared”;

FIG. 10 is a flowchart illustrating an example of the processing procedure of the file management unit when the status is “Invalid”;

FIG. 11 is a flowchart illustrating an example of the processing procedure of the file management unit when the status is “Invalid”;

FIG. 12 is a sequence diagram illustrating an example of the processing when the status of the frontend that performs reference is “Invalid”;

FIG. 13 is a sequence diagram illustrating an example of the processing when the status of the frontend that performs the update is “Invalid”;

FIG. 14 is a flowchart illustrating an example of a responding processing procedure by the file management unit;

FIG. 15 is a flowchart illustrating another example of the responding processing procedure by the file management unit;

FIG. 16 is a diagram illustrating a transition example of the status;

FIG. 17 is a flowchart illustrating an example of writing processing from the off-core cache into a backend; and

FIG. 18 is a flowchart illustrating an example of a data recovery processing procedure by the file management unit of a representative server.

### DESCRIPTION OF EMBODIMENTS

The embodiments will be described below with reference to the diagrams.

### First Embodiment

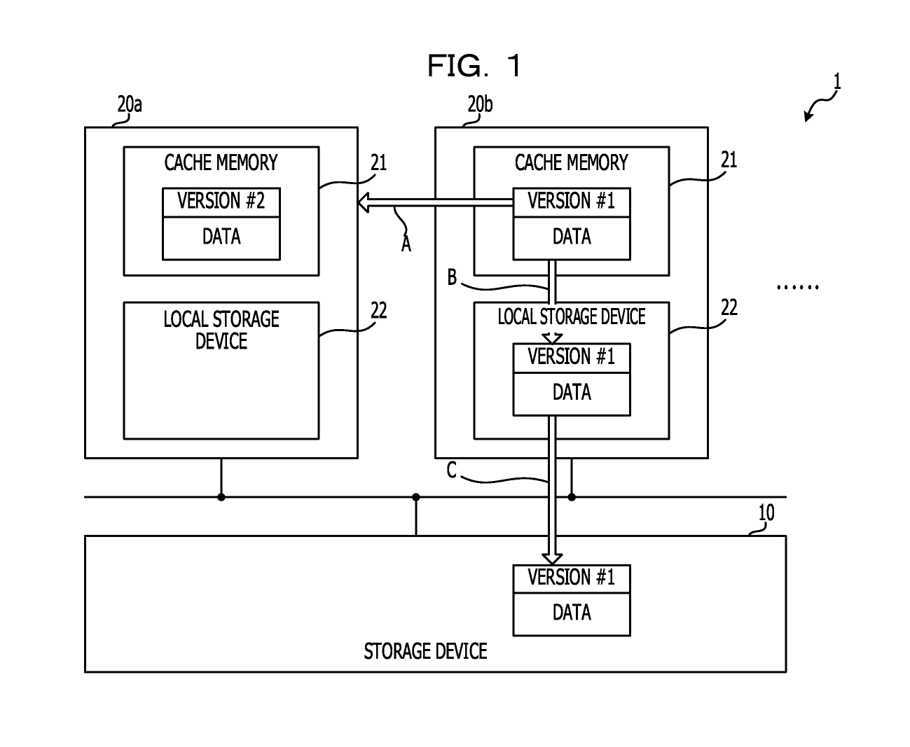

FIG. 1 is a diagram illustrating an example of a configuration and an operation of a storage system according to a first embodiment. The storage system illustrated in FIG. 1 includes a storage device 10 and access control devices 20a, 20b, etc. The storage device 10 and the access control devices 20a, 20b, etc. are coupled to each other through a network. The number of access control devices to be allocated is arbitrary.

The storage device 10 stores a file. Each of the access control devices 20a, 20b, etc. controls access to the storage device 10. Each of the access control devices 20a, 20b, etc. includes a cache memory 21. For example, the file to be stored in the storage device 10 is temporally stored in the blocks with a fixed length in the cache memory 21.

Each of the access control devices 20a, 20b, etc. may include a local storage device 22. The cache memory 21 is a volatile storage device. The local storage device 22 is a non-volatile storage device.

In a storage system 1, the file to be stored in the storage device 10 is managed by a log-structured file system. When the block of the file stored in the storage device 10 is updated, the data of the updated block is stored in a storage area that is different from the storage area in which the data of the block before the update. Thus, the block before the update is not overwritten.

On the other hand, each of the access control devices adds a version number to the data of the block and then stores the data in the cache memory 21. The version number is changed into a new value every time the data of the block is updated. By the processing described below, even when the latest data of the block is stored in the cache memory 21 of any access control device, each of the access control devices 20a, 20b, etc. may generate and add a correct version number to the data when the data of the block is updated.

Below is a description of a processing example of a case where the access control device 20a updates a prescribed block in response to a request from a user terminal device or the like that is not illustrated. It is assumed that the latest data of the prescribed block is stored in the cache memory 21 of the access control device 20b but not in the cache memory 21 of the access control device 20a. At this point, “version#1” as a version number is added to the latest data.

In this state, when the access control device 20a updates the data of the prescribed block, the following processing is performed. The access control device 20a obtains the version number “version #1” added to the latest data from the access control device 20b that holds the latest data (corresponding to an arrow A). The access control device 20a stores the updated data of the prescribed block in the cache memory 21 of the access control device 20a. The access control device 20a generates another number “version #2” based on the version number obtained from the access control device 20b and then adds the version number “version #2” to the updated data.

According to the above-described processing, the access control device 20a may add a correct version number to the updated data. Therefore, the access control device 20a may manage the number of versions of data stored in the cache memory 21 of the access control device 20a. As for the entire storage system 1, the number of versions of the data regarding the same block stored in the cache memory 21 regarding the same block may be properly managed. Therefore, in the system using the dispersion cache, the log-structured file system may be used to manage the file.

It is preferable that the access control device 20b appends the data of “version #1” to a non-volatile storage device before permitting the access control device 20a to update the data of the prescribed block. As a result, the access control device 20a may surely store the data before the update. According to the appending method as a recording method, when the data of the same block to which an older version number is added is stored in the non-volatile storage device, the data may be left.

The storage destination to which the data in the cache memory 21 is appended may be the storage device 10. However, for example, the access control device 20b may append the data in the cache memory 21 to the local storage device 22 (corresponding to an arrow B). The access control device 20b appends the data and the version number stored in the local storage device 22 to the storage device 10 at an arbitrary timing that is not synchronized with a storing timing into the local storage device 22 (corresponding to an arrow C).

Accordingly, the appending of data may be performed at a higher speed as compared with the appending of data to the storage device 10. As a result, the time until the data update is permitted with respect to the access control device 20a may be shortened.

### Second Embodiment

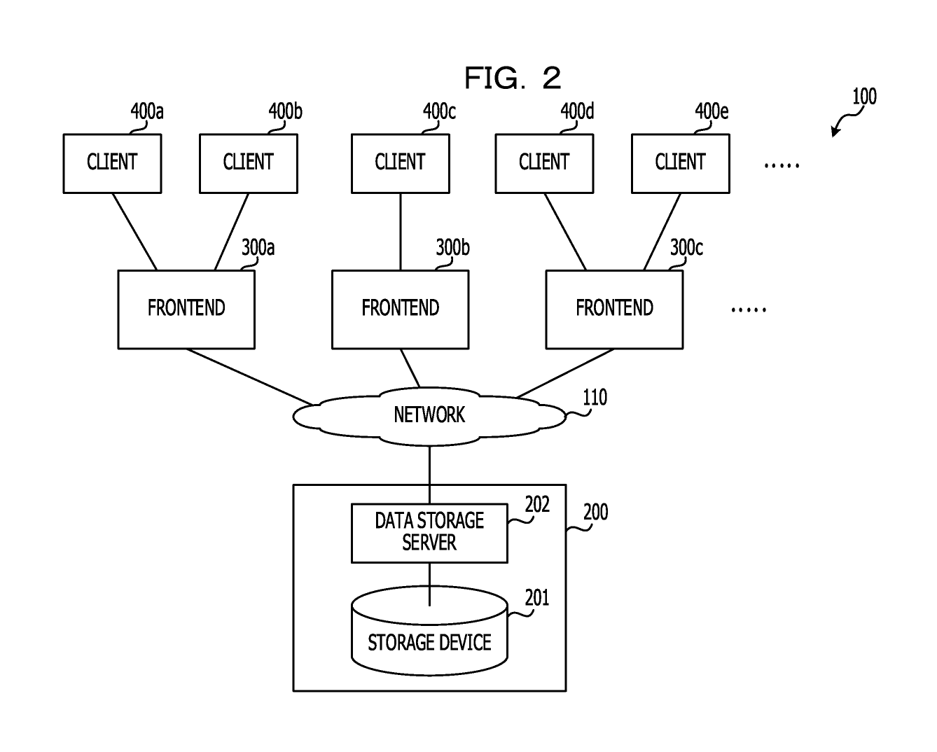

FIG. 2 is a diagram illustrating an example of a whole configuration of a storage system according to a second embodiment. A storage system 100 illustrated in FIG. 2 includes a backend 200, frontends 300a to 300c, and clients 400a to 400e.

The backend 200 provides the clients 400a to 400e with a non-volatile storage area with a large capacity. In the example illustrated in FIG. 2, the above-described storage area is achieved by a storage device 201. The backend 200 includes a data storage server 202 that controls reading and writing of data with respect to the storage device 201. The backend 200 is included in, for example, an object storage.

The data storage server 202 uses the log-structured file system to manage the data to be stored in the storage device 201. When the update of the file stored in the storage device 201 is desired, the data storage server 202 appends the updated file to the storage device 201 without overwriting the file before the update. According to the above-described file management method, the data storage server 202 may output, for example, a snap shot of the file at an arbitrary update point.

The description below includes “store the data in the backend 200” when the data is stored in the storage device 201 through the data storage server 202. Reading out the data from the storage device 201 through the data storage server 202 is indicated as “reading out the data from the backend 200.”

The frontends 300a to 300c are coupled to the data storage server 202 of the backend 200 through a network 110. The frontends may communicate with each other through the network 110. The number of frontends to be coupled to the backend 200 is arbitrary.

One or more clients are coupled to each of the frontends 300a to 300c. In the example of FIG. 2, the clients 400a and 400b are coupled to the frontend 300a, the client 400c is coupled to the frontend 300b, and the clients 400d and 400e are coupled to the frontend 300c.

Each of the frontends 300a to 300c as an example of the access control device illustrated in FIG. 1 is a server device that provides the backend 200 with an interface. In response to a request from a client, each of the frontends 300a to 300c controls the data storage into the backend 200 and the data reading from the backend 200.

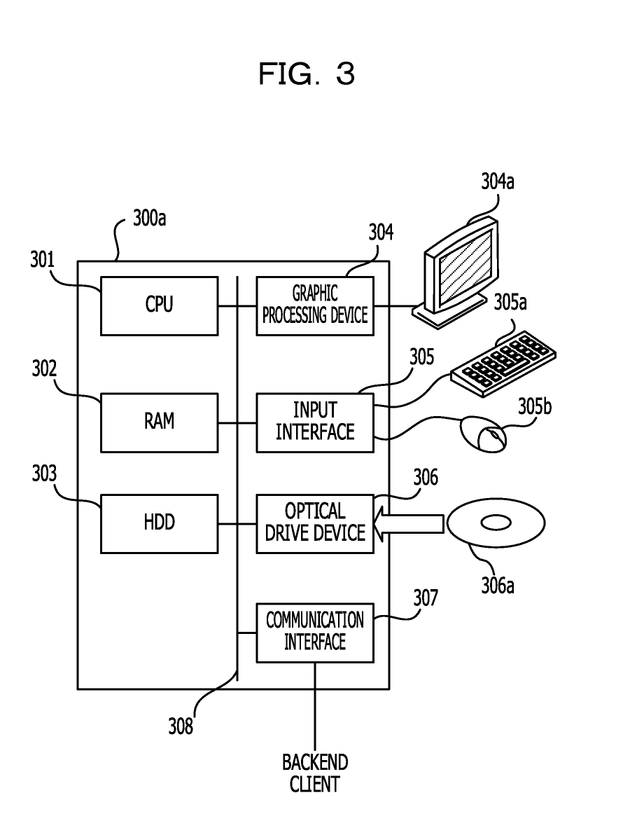

Each of the clients 400a to 400e is a user terminal device that is used by a user to access the backend 200. FIG. 3 is a diagram illustrating an example of a hardware configuration of a frontend. In FIG. 3, although the frontend 300a is illustrated as an example, the frontends 300b and 300c are also achieved by the similar hardware configuration.

The frontend 300a may be achieved as the computer illustrated in FIG. 3. The entire frontend 300a is controlled by a Central Processing Unit (CPU) 301. The CPU 301 is coupled to a Random Access Memory (RAM) 302 and a plurality of peripheral devices via a bus 308.

The RAM 302 is used as a main storage device of the frontend 300. The RAM 302 temporally stores at least part of an Operating System (OS) program or an application program to be executed by the CPU 301. The RAM 302 stores various data desired for the processing to be performed by the CPU 301.

A Hard Disk Drive (HDD) 303, a graphic processing device 304, an input interface 305, an optical drive device 306, and a communication interface 307 are the peripheral devices coupled to the bus 308.

The HDD 303 writes and reads out the data into and from a magnetic disk provided inside thereof. The HDD 303 is used as a secondary storage device of the frontend 300. The HDD 303 stores an OS program, an application program, and various types of data. Another type of the non-volatile storage device such as a Solid State Drive (SSD) may be used as the secondary storage device.

A monitor 304a is coupled to the graphic processing device 304. According to an order from the CPU 301, the graphic processing device 304 displays an image on the monitor 304a. The monitor 304a is, for example, a liquid crystal display.

Input devices such as a keyboard 305a and a mouse 305b are coupled to the input interface 305. The input interface 305 transmits an output signal from the input device to the CPU 301.

The optical drive device 306 uses a laser light or the like to read the data stored in an optical disk 306a. The optical disk 306a is a portable recording medium in which data is recorded to be readable by reflection of light. A Digital Versatile Disc (DVD), a DVD-RAM, a CD-ROM (Compact Disc Read Only Memory), a CD-R (Recordable)/RW (Rewritable), or the like is used as the optical disk 306a.

The communication interface 307 transmits and receives data to and from another device such as the data storage server 202 of the backend 200 or the clients 400a to 400e and the like through the network.

In the above-described hardware configuration, the frontends 300a to 300c according to the embodiments are achieved. The data storage server 202 and the clients may be achieved as the computer illustrated in FIG. 3.

Each of the frontends 300a to 300c includes a function for caching the data that is desired to be stored in the backend 200 or the data that is to be stored in the backend 200 in the memory thereof. The cache data is dispersed and allocated in the plurality of frontends 300a to 300c, each of the frontends 300a to 300c is preferably to manage the cache data by using the dispersion cache file system so that the cache coherency is maintained.

There is a method for managing the dispersion cache to maintain the cache coherency. According to this method, for example, when the update of cache data occurs in a plurality of nodes at substantially the same time, the cache data before the update in the node in which the cache data is updated in advance is reflected on the backend and the right of update in the node is deprived. After the right of update is deprived, the right of update is given to the following node.

However, according to the embodiments, the data of the backend 200 is managed by using the log-structured file system. Therefore, it is preferable that in the storage system 100 according to the embodiments, the updated cache data remains without being overwritten every time the update occurs. This function is not mounted on the above-described dispersion cache management method, the dispersion cache managing method may not be applied to the log-structured file system.

In the above-described dispersion cache managing method, the updated cache data is stored in the backend 200 every time the cache data is updated. In this manner, the method for updating the cache data may not be performed until the updated cache data is stored in the backend 200. Therefore, when many update requests for the cache data are transmitted, it takes a long time to reply a response to all the update requests. Especially, the response performance of the object storage is not high, so that the response speed is dynamically decreased if the backend 200 is an object storage.

As for the MSI protocol as a cache coherency protocol in a multi-processor system, a method for preventing occurrence of overhead by writing into a main storage as the processor directly transmits the cache data after the update to the processor has been employed. However, the MSI protocol may not leave the cache data every time the update occurs, so that the method may not be applied to the log-structured file system.

To solve the above-described problem, the frontends 300a to 300c according to the embodiments are able to leave the cache data every time the update occurs. Further, the frontends 300a to 300c includes the dispersion cache file system in which the time desired for the update of cache data is shortened.

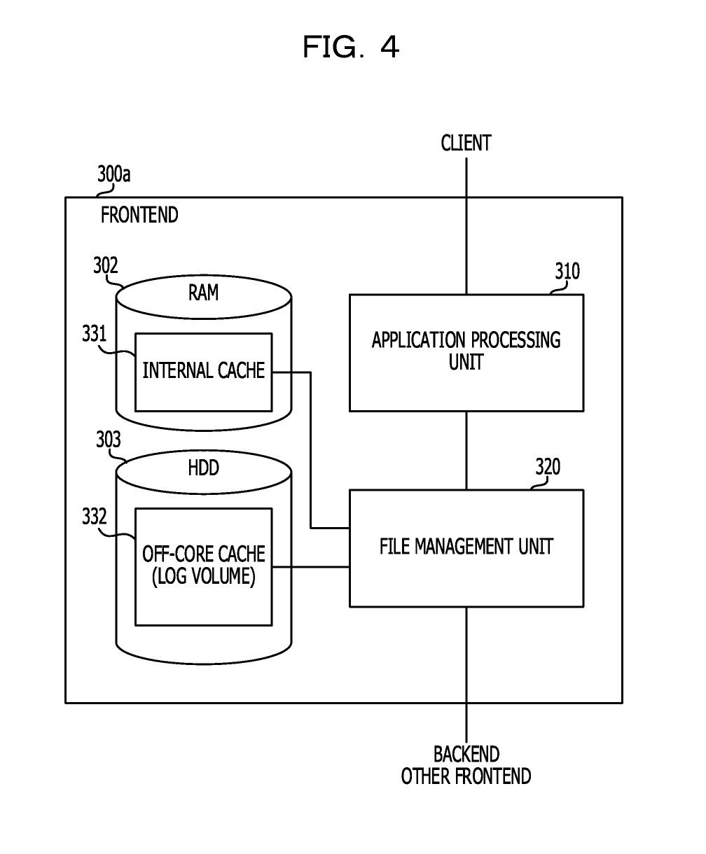

FIG. 4 is a block diagram illustrating an example of a configuration of a processing function included in the frontend. FIG. 4 illustrates the frontend 300a, for example. The frontends 300b and 300c include the similar processing function.

The frontend 300a includes an application processing unit 310 and a file management unit 320. The application processing unit 310 is achieved, for example, when the CPU 301 of the frontend 300a executes a prescribed application program. There is a program for accessing the database, for example, as an application program.

When receiving the data writing request from a client, the application processing unit 310 transmits a request for updating the data to the file management unit 320. When receiving the data reading request from a client, the application processing unit 310 transmits a data reference request to the file management unit 320 and then transmits the data replied from the file management unit 320 to the client.

The file management unit 320 is achieved, for example, when the CUP 301 of the frontend 300a executes an OS program. The file management unit 320 functions as a file system that manages the data stored in the backend 200. The file management unit 320 provides the application processing unit 310 with an Application Program Interface (API) to access a file.

The file management unit 320 identifies the file based on the identification information called “inode number.” The file management unit 320 divides the file into blocks with a fixed size and manages the storage area in each block.

The RAM 302 of the frontend 300a secures the area of an internal cache 331. The HDD 303 of the frontend 300a secures the area of an off-core cache 332. The file management unit 320 achieves the cache function by using the dispersion cache file system by using each area of the internal cache 331 and of the off-core cache 332.

When receiving the update request of the block from the application processing unit 310, the file management unit 320 stores the update data in the internal cache 331 and the off-core cache 332. The off-core cache 332 non-volatilizes the update data stored in the internal cache 331 and functions as a log volume so that the update data is recovered when an error occurs. The file management unit 320 stores the update data, which is stored in the off-core cache 332, in the backend 200 at a timing that is not synchronized with the storage timing into the off-core cache 332.

The file management unit 320 manages the state of each block according to three statuses: “Modified,” “Shared,” and “Invalid.” Each status is defined as below.

Modified: The latest update data is stored in the internal cache 331 of a frontend but not in the off-core cache 332 of the frontend. When receiving the update request or the reference request corresponding to the block from another frontend, the frontend is desired to store the latest data of the block in the off-core cache 332 of the frontend before permitting the other frontend to update or reference the block.

Shared: The latest update data is stored in both the internal cache 331 and the off-core cache 332 of a frontend. In a plurality of frontends, the status of the same block may be “Shared.”

Invalid: The latest update data is not stored in the internal cache 331 or the off-core cache 332 of a frontend. The file management unit 320 adds another version number to the updated data every time when the data of the block is updated. The file management unit 320 includes a function for transmitting the latest version number of the update data that is included in the frontend.

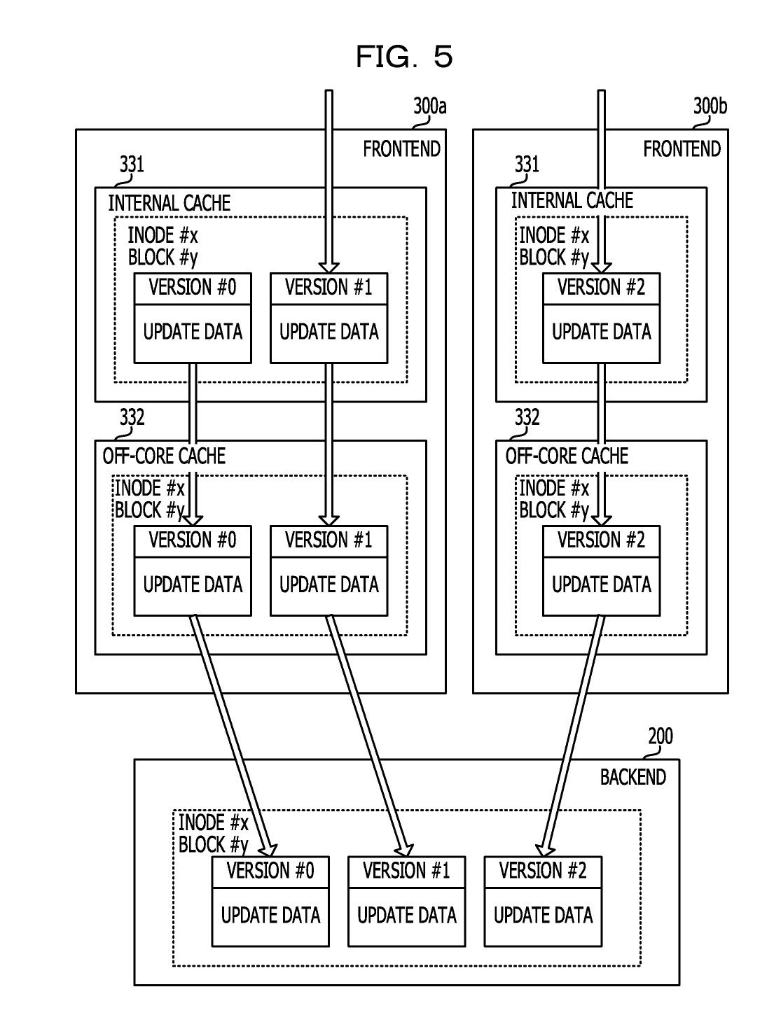

FIG. 5 is a diagram illustrating an example of cache control by using the internal cache and the off-core cache. FIG. 5 illustrate, for example, update processing by the frontends 300a and 300b regarding the block that is identified by an inode number “inode #x” and a block number “block #y.” Hereinafter, the block identified by an inode number “inode #x” and the block number “block #y” is referred to as “block XY.”

In FIG. 5, the block XY is updated in the frontend 300a. At this point, the file management unit 320 of the frontend 300a stores the update of the block XY in the internal cache 331 of the frontend 300a and changes the status of the block XY into “Modified.” At the same time, the file management unit 320 of the frontend 300a generates, for example, “version #1” as the latest version number with respect to the block XY and then stores the generated “version #1” in the internal cache 331 in association with the update data.

In the frontend 300b, the update request with respect to the same block XY occurs. When the frontend 300b does not hold the latest data at least (that is, the status of the block XY is “Invalid”), the file management unit 320 of the frontend 300b broadcasts the report request of the status and the version number on a network 110. After receiving the report request, the file management unit 320 of the other frontend replies the status and the version number of the block XY of the other frontend by broadcast.

Based on the information replied in response to the report request, the file management unit 320 of the frontend 300b recognizes the latest data of the block XY and the latest version number of the block XY. In the example of FIG. 5, the file management unit 320 of the frontend 300b recognizes that the latest data of the block XY is held in the frontend 300a and that the version number is “version #1.” The file management unit 320 of the frontend 300b transmits an update request of the block XY to the frontend 300a.

When receiving the update request of the block XY, the file management unit 320 of the frontend 300a copies the latest data of the block XY stored in the internal cache 331 together with the version number into the off-core cache 332 if the status of the block is “Modified.” After completing copying the latest data and the version number, the file management unit 320 of the frontend 300a changes the status of the block XY into “Invalid” and transmits a response to the frontend 300b to permit the update of the block XY.

After the latest data of the block XY stored in the internal cache 331 of the frontend 300a is stored in the off-core cache 332, the cache coherency may be maintained when the status of the block XY is changed. At the same time, after the latest data of the block XY is stored together with the version number in the off-core cache 332, the update of the block XY in another frontend 300b is permitted. Thus, before the block XY is updated in the other frontend 300b, the data before the update is surely stored together with the version number in a non-volatile state.

When the off-core cache 332 stores the update data of an old version of the same block XY, the file management unit 320 of the frontend 300a does not overwrite the latest data in the internal cache 331 on the update data of the old version but appends the latest data to the off-core cache 332. Due to this, the previous update data is surely maintained in the non-volatile recording medium.

In the example illustrated in FIG. 5, the off-core cache 332 of the frontend 300a stores the update data in which “version #0,” which is older than “version #1,” is added to the off-core cache 332 of the frontend 330a. In this case, the off-core cache 332 of the frontend 300a stores the update data of “version #1” in an area separately from the update data of “version #0”.

The off-core cache 332 is a storage device that is locally coupled to the frontend 300a. Thus, the speed of writing data into the off-core cache 332 is higher than the speed of writing data into the backend 200. When storing the latest data, which is stored simply in the internal cache 331, in the off-core cache 332 instead of the backend 200, the file management unit 320 of the frontend 300a permits the update of the same block in the other frontend 300b. Due to this, the time before the update of the block XY is permitted by the other frontend 300b is shortened. In other words, the processing time before the update is completed after the update of the block is requested is shortened, so that the response speed of the frontend 300b is increased.

When receiving the response in response to the update request from the frontend 300a, the file management unit 320 of the frontend 300b updates the block XY by storing the new update data of the block XY in the internal cache 331. At this point, the file management unit 320 of the frontend 300b generates a new version number “version #2” and stores the version number in the internal cache 331 in association with the update data.

As described above, the file management unit 320 of the frontend 300b has already obtained, from the frontend 300a, the version number “version #1” before the update regarding the block XY. Therefore, the file management unit 320 of the frontend 300b may determine the new version number that is to be added to new update data of the block XY. In this manner, when the new version number is added to the new update data, the update data of the same block is stored to be distinguishable for each generation in the dispersion cache structured inside the storage system 100.

According to the above-described processing, the off-core cache 332 of the frontend 300a stores the update data of “version #0” and the update data of “version #1” as the update data of the block XY. The file management unit 320 of the frontend 300a appends each update data of “version #0” and “version #1” stored in the off-core cache 332 to the backend 200.

For example, when the update of the block XY in the other frontend occurs, the file management unit 320 of the frontend 300b copies the update data of “version #2” stored in the internal cache 331 into the off-core cache 332. Further, the file management unit 320 of the frontend 300b appends the latest data of “version #2” stored in the off-core cache 332 to the backend 200 at an arbitrary timing.

In this manner, the update data of the respective generations stored in the off-core cache 332 of each frontend is stored in the backend 200. Therefore, each frontend may manage the data, which is to be stored in the backend 200, by the log-structured file system.

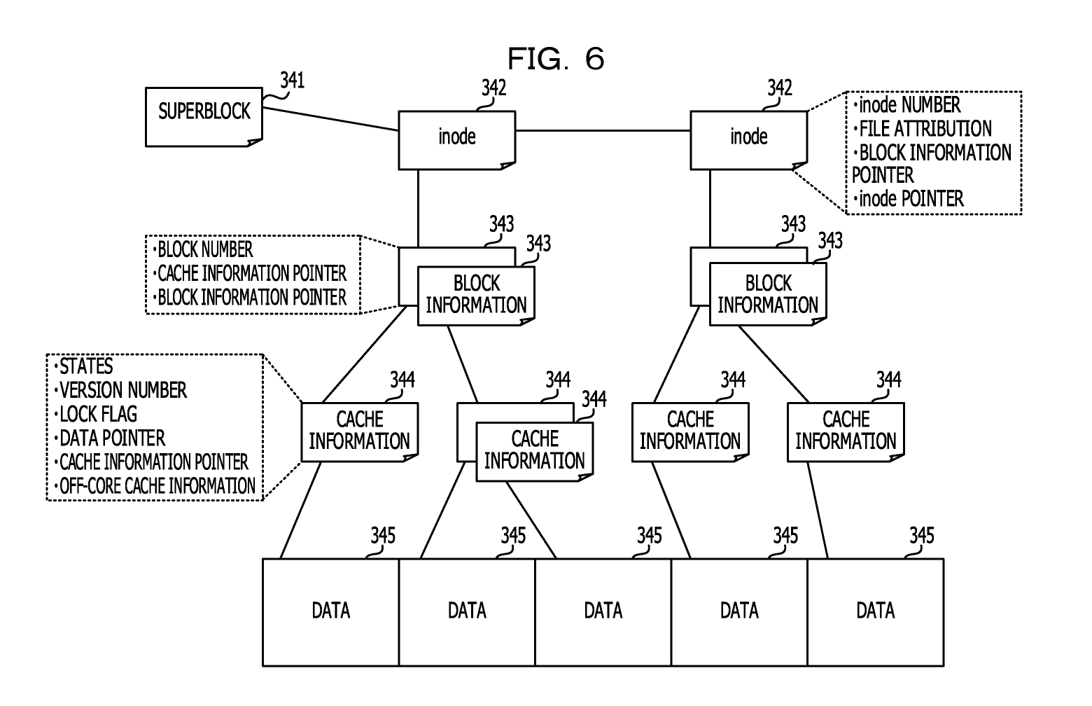

FIG. 6 is a diagram illustrating an example of a database structure for file management by a file management unit. By using the database structure illustrated in FIG. 6, the file management unit 320 of each frontend manages the file to be stored in a cash memory of their own.

Basic information related to the file system such as the number of inodes 342 included in the file system, for example, is written into a superblock 341. A pointer indicating the position on the RAM 302 of the head inode 342 is written into the superblock 341, and this pointer specifies the head inode 342.

For example, an inode number, a file attribute, a block information pointer, and an inode pointer are written in the inode 342. The inode number is information that identifies a file. Therefore, the inode 342 is generated for each file. The file attribute indicates the attribute of a file. The block information pointer indicates a position on the RAM 302 of block information 343 corresponding to the inode number. The inode pointer indicates a position on the RAM 302 of another inode. The inode pointer couples two inodes 342 in a list structure.

The information related to each block obtained by dividing the file is written into the block information 343. For example, a block number, a cache information pointer, and a block information pointer are written into the block information 343.

The block number is information that identifies a block. The cache information pointer is a pointer indicating a position on the RAM 302 of the cache information corresponding to the block. The block information pointer indicates the position on the RAM 302 of the block information 343 corresponding to the other block belonging to the same file when the file is divided into a plurality of blocks.

The information related to data 345 of the block that is identified by the inode number and the block number is written into cache information 344. For example, a status, a version number, a lock flag, a data pointer, a cache information pointer, and off-core cache information are written into the cache information 344.

The status indicates “Modified,” “Shared,” or “Invalid” as described above. The version number is information newly added to the data 345 every time the update is performed. The lock flag is flag information indicating whether the reference or update of the corresponding block is possible. The lock flag is set to “0” when the reference or update is possible. The lock flag is set to “1” when the reference or update is impossible.

The data pointer indicates a position on the RAM 302 of the corresponding data 345. According to the data pointer, the cache information 344 is associated with the data 345 on the RAM 302.

As for the block that is identified by the inode number and the block number, when a plurality of blocks of data 345 with different version numbers is stored in the RAM 302, a plurality of pieces of cache information 344 is stored in the RAM 302. The cache information pointer indicates the position on the RAM 302 of the cache information corresponding to the data 345 with another version number. The cache information pointer couples two pieces of cache information 344 in a list structure.

The off-core cache information indicates a position in the off-core cache 332 of the corresponding data 345 when the corresponding data 345 is stored also in the off-core cache 332.

When the plurality of pieces of cache information 344 regarding the same block is stored, an effective status and a lock flag regarding the block are the status and the lock flag written in the cache information 344 that includes the latest version number.

The information that is similar to the information written in the above-described inode 342, block information 343, and cache information 344 is stored also in the off-core cache 332. As a result, even when the frontend abnormally stops, the above-described information may be recovered from the off-core cache 332. In the off-core cache 332, the contents of the above-described information may be recorded in a structure that is different from FIG. 6. In the off-core cache 332, the inode pointer, the block information pointer, and the cache information pointer in the above-described information are converted to indicate the position on the HDD 300 instead of the position on the RAM 302.

The processing of the file management unit 320 of each frontend will be described below with a flowchart. As necessary, a sequence diagram indicting a processing example of the file management unit 320 of a plurality of frontends is provided.

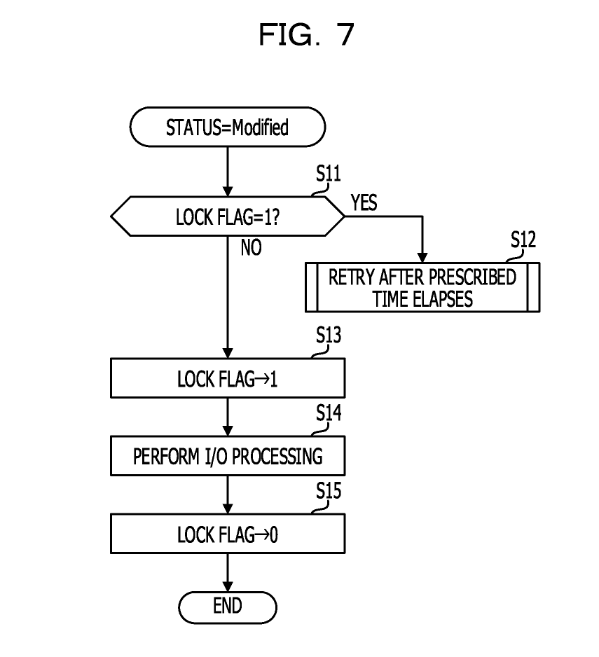

In FIGS. 7 to 13, the processing of the file management unit 320 in a case where an In/Out (I/O) request is output to the block from the application processing unit 310 is illustrated in divisions of each status of the target block.

FIG. 7 is a flowchart illustrating an example of a processing procedure of the file management unit when the status is “Modified.” [Operation S11] The file management unit 320 determines whether the lock flag of the block is “1.” If the lock flag is “1,” the file management unit 320 performs the processing of Operation S12. If the lock flag is “0,” the file management unit 320 performs the processing of Operation S13.

[Operation S12] If the lock flag is “1,” the update and reference of the corresponding block is prohibited. Therefore, the file management unit 320 retries the requested I/O processing after a prescribed time elapses. Since the status of a target block may be changed after the prescribed time elapses, the file management unit 320 retries the processing according to the status of the target block.

[Operation S13] The file management unit 320 changes the lock flag of the block into “1,” and the update and reference of the block from the other frontend is prohibited. [Operation S14] The file management unit 320 performs the I/O processing. If the reference is requested, the file management unit 320 reads out, from the internal cache 331, the latest data of the block into the application processing unit 310. If the update is requested, the file management unit 320 stores new update data received from the application processing unit 310 in the internal cache 331 and then updates the block.

When updating the block in Operation S14, the file management unit 320 may overwrite the update data with the latest version number stored in the internal cache 331 with new update data. In this case, every time the block is updated in a different frontend, the update data with the new version number is stored.

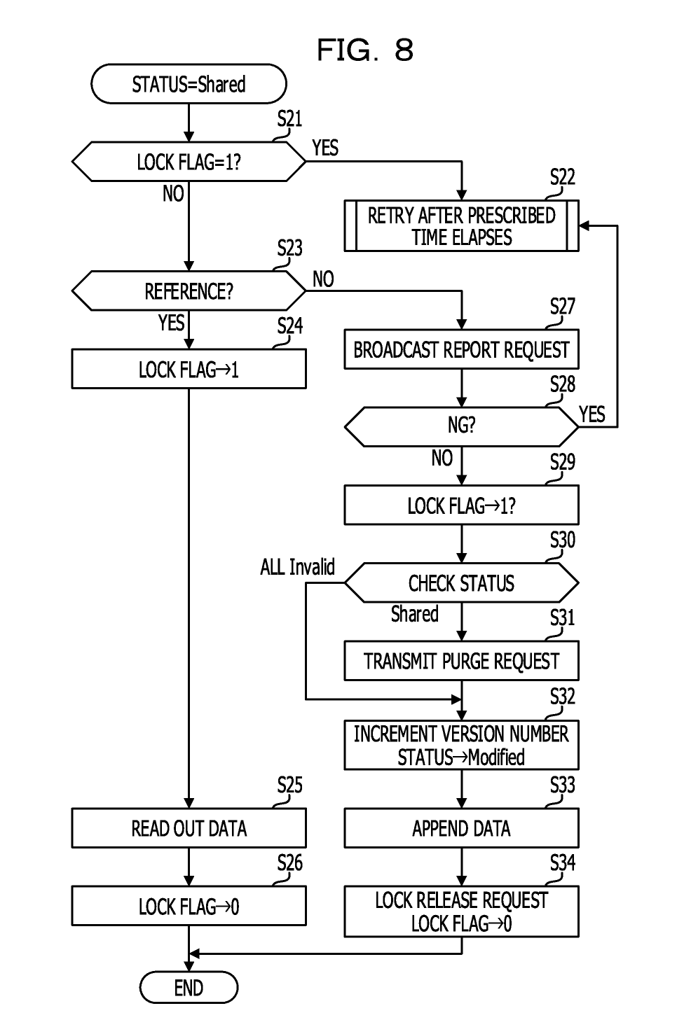

As another example, when the block is updated in Operation S14, the file management unit 320 may add the new version number to the new update data and may append the new update data and the new version number to the internal cache 331. In this case, regardless of position of the frontend where the update is performed, the update data with the new version number is stored every time the block is updated.

[Operation S15] The file management unit 320 changes the lock flag of the flag into “0” to release the locked state. FIG. 8 is a flowchart illustrating an example of a processing procedure of the file management unit when the status is “Shared.”

[Operation S21] The file management unit 320 determines whether the lock flag of the block is “1.” If the lock flag is “1,” the file management unit 320 performs the processing of Operation S22. If the lock flag is “0,” the file management unit 320 performs the processing of Operation S23.

[Operation S22] The file management unit 320 retries the requested I/O processing in a procedure similar to Operation S12 in FIG. 7 after the prescribed time elapses. [Operation S23] If the reference is requested, the file management unit 320 performs the processing of Operation S24. If the update is requested, the file management unit 320 performs the processing of Operation S27.

[Operation S24] The file management unit 320 changes the lock flag of the block into “1,” and prohibits the update and reference of the block from the other frontends. [Operation S25] The file management unit 320 reads out, from the internal cache 331, the latest data of the block into the application processing unit 310.

[Operation S26] The file management unit 320 changes the lock flag of the block into “0” to release the locked state. [Operation S27] The file management unit 320 broadcasts the report request of the status and the version information to other frontends.

[Operation S28] The file management unit 320 receives the response in response to the report request from the other frontends. If there is an NG response in the received responses, the file management unit 320 locks the block as an update target and then determines that the reference and update of the block is prohibited. In this case, the process goes to Operation S22. The management unit 320 retries the update processing. If there is no NG response in the received responses, the file management unit 320 performs the processing of Operation S29.

[Operation S29] In Operation S28, if there is no NG response in the received responses, the file management unit 320 determines that the lock of the block as an update target is achieved. In this case, the file management unit 320 changes the lock flag of the block into “1” and prohibits the update and reference of the block from the other frontends.

[Operation S30] The file management unit 320 checks the status of the block as an update target in the other frontends based on the response received from the other frontends in Operation S28. If all the statuses of the other frontends are “Invalid,” the file management unit 320 performs the processing of Operation S32. If one of the other frontends has the status “Shared,” the file management unit 320 performs the processing of Operation S31.

[Operation S31] The frontend with the “Shared” status holds the latest data of the block as an update target. Therefore, the file management unit 320 transmits the purge request to the frontend with the “Shared” status to change the status into “Invalid.”

[Operation S32] The file management unit 320 increments the latest version number of the block as an update target to generate a new version number. The file management unit 320 changes the status of the block as an update target into “Modified.”

[Operation S33] The file management unit 320 appends the new update data received from the application processing unit 310 together with the generated new version number to the internal cache 331. As a result, the data of the block is updated.

[Operation S34] The file management unit 320 broadcasts the lock release request to release the prohibition state of the reference and update of the target block in the other frontends. The file management unit 320 changes the lock flag into “0.”

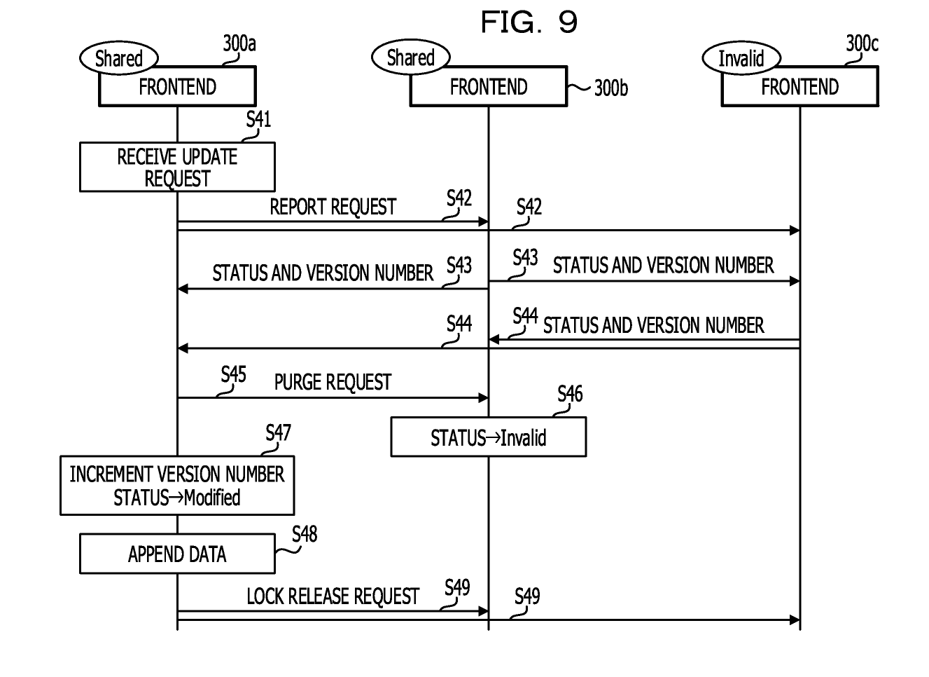

FIG. 9 is a sequence diagram illustrating an example of the processing in a case where the status of the frontend that performs the update is “Shared.” In FIG. 9, the status of the block as an update target in an initial state is “Shared” in the frontends 300a and 300b and “Invalid” in the frontend 300c.

[Operation S41] The file management unit 320 of the frontend 300a receives the update request of the block from the application processing unit 310. [Operation S42] The file management unit 320 of the frontend 300a broadcasts the report request of the status and version information to the other frontends (corresponding to Operation S27 illustrated in FIG. 8).

[Operation S43] The file management unit 320 of the frontend 300b broadcasts the response in response to the report request. As for the response information transmitted from the frontend 300b, the “Shared” status is set and the latest version number of the block at the present moment is set.

[Operation S44] The file management unit 320 of the frontend 300c broadcasts the response in response to the report request. As for the response information transmitted from the frontend 300c, the “Invalid” status is set and the latest version number among the version numbers added to the data held by the frontend 300c is set.

Operations S43 and S44 may be performed in the reverse order or may be performed concurrently. As described below, when receiving the report request, the frontend broadcasts normal response information when the target block is not locked (when the lock flag is “0”). When receiving the report request, the frontend broadcasts NG response information when the target block is locked (when the lock flag is “1”).

Since the response information is broadcasted, the frontend that transmits the response information may receive the response information transmitted from the other frontends. The frontend that transmits the normal response information transfers to the locked state when the NG response information is not received from the other frontends. When the normal response information is replied from all the frontends that receive the report request, not simply the frontend of the transmission source of the report request achieves the locked state but also the other frontends are in the locked state, so that exclusion control of the reference or the update is easily performed.

[Operation S45] If the file management unit 320 of the frontend 300a that receives the response information determines that the NG response is not received, the file management unit 320 transmits the purge request to the frontend 300b with the “Shared” status (Operation S31 in FIG. 8).

[Operation S46] The file management unit 320 of the frontend 300b that receives the purge request changes the status of the target block into “Invalid.” [Operation S47] The file management unit 320 of the frontend 300a increments the latest version number of the block as an update target to generate a new version number. The file management unit 320 changes the status of the block as an update target into “Modified” (corresponding to Operation S32 in FIG. 8).

[Operation S48] The file management unit 320 of the frontend 300a appends the new update data together with the generated new version number to the internal cache 331 (corresponding to Operation S33 in FIG. 8).

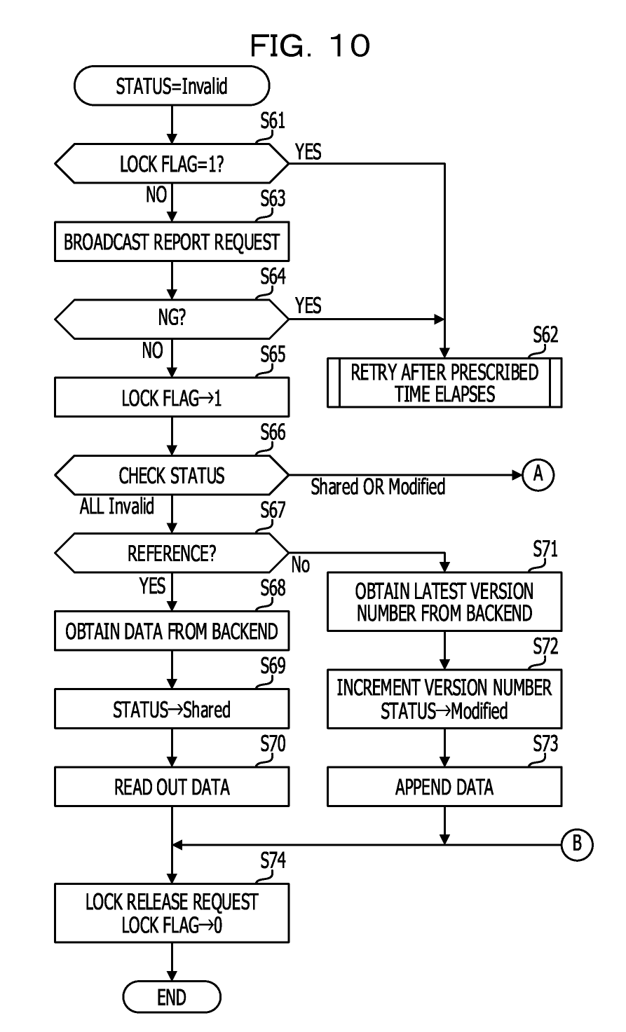

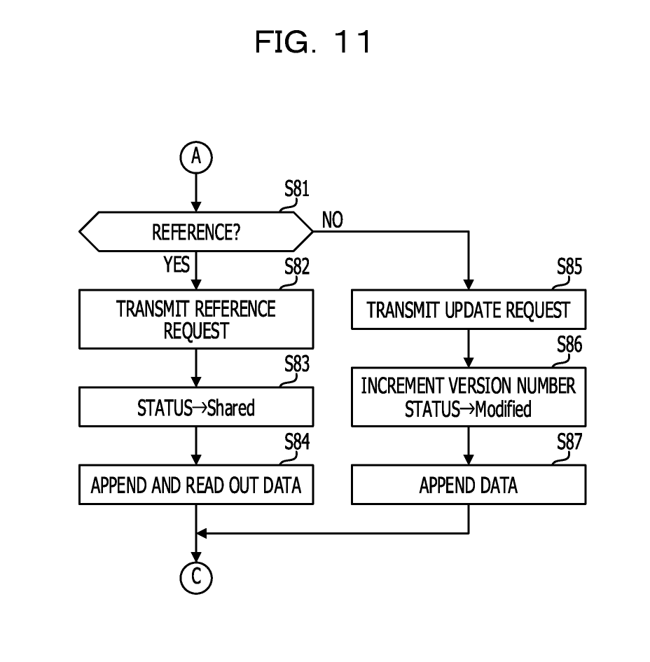

As described above, the frontend 300a performs block updating processing of Operations S47 and S48 after transmitting the purge request to the frontend 300b with the “Shared” status. As a result, the cache coherency may be maintained.

[Operation S49] The file management unit 320 of the frontend 300a broadcasts the lock release request (corresponding to Operation S34 in FIG. 8). FIGS. 10 and 11 are flowcharts illustrating an example of the processing procedure of the file management unit in a case where the status is “Invalid.”

[Operation S61] The file management unit 320 determines whether the lock flag of the block is “1.” If the lock flag is “1,” the file management unit 320 performs the processing of Operation S62. If the lock flag is “0,” the file management unit 320 performs the processing of Operation S63.

[Operation S62] The file management unit 320 retires the requested I/O processing in the procedure that is similar to Operation S12 illustrated in FIG. 7 after the prescribed time elapses. [Operation S63] The file management unit 320 broadcasts the report request of the status and the version information to the other frontends.

[Operation S64] The file management unit 320 receives the response in response to the report request from the other frontends. When there is an NG response in the received responses, the file management unit 320 determines that the block as an update target is blocked and that the reference and the update of the block are prohibited. In this case, the process goes to Operation S62. The file management unit 320 retries the update processing. If there is no NG response in the received responses, the file management unit 320 performs the processing of Operation S65.

[Operation S65] If there is no NG response in the received responses in Operation S64, the file management unit 320 determines that the lock of the update target block is achieved and changes the lock flag of the block into “1.”

[Operation S66] The file management unit 320 checks the status of the block as an update target in the other frontends based on the response received from the other frontends in Operation S64. When all the status of the other frontends is “Invalid,” the file management unit 320 performs the processing of Operation S67. If one of the statuses of the other frontends is “Shared” or “Modified,” the file management unit 320 performs the processing of Operation 81 illustrated in FIG. 11.

[Operation S67] When the reference is requested, the file management unit 320 performs the processing of Operation S68. When the update is requested, the file management unit 320 performs the processing of Operation S71.

[Operation S68] The file management unit 320 obtains the latest data of the block and the version number added to the block from the backend 200. The file management unit 320 stores the obtained latest data and version number in the off-core cache 332 and the internal cache 331.

[Operation S69] The file management unit 320 changes the status of the block as a reference target into “Shared.” [Operation S70] The file management unit 320 reads out the latest data stored in the internal cache 331 in Operation S68 into the application processing unit 310.

[Operation S71] The file management unit 320 obtains the latest version number of the block from the backend 200. [Operation S72] The file management unit 320 increments the obtained version number to generate a new version number. The file management unit 320 changes the status of the block as an update target into “Modified.”

[Operation S73] The file management unit 320 appends the new update data received from the application processing unit 310 together with the generated new version number to the internal cache 331. Due to this, the data of the block is updated.

[Operation S74] The file management unit 320 broadcasts the lock release request and changes the lock flag of the block into “0” to release the locked state. [Operation S81] When the reference is requested, the file management unit 320 performs the processing of Operation S82. When the update is requested, the file management unit 320 performs the processing of Operation S85.

[Operation S82] The file management unit 320 transmits the reference request to the other frontend of which the status is “Modified” or “Shared.” The file management unit 320 receives the latest data of the block and the version number added to the block as a response corresponding to the reference request.

[Operation S83] The file management unit 320 changes the status of the block into “Shared.” [Operation S84] The file management unit 320 appends the data and the version number received in Operation S82 to the off-core cache 332 and the internal cache 331. The file management unit 320 reads out the data stored in the internal cache 331 into the application processing unit 310.

In Operation S82, the file management unit 320 may receive simply the latest data of the block as a response corresponding to the reference request. In this case, in Operation S84, the file management unit 320 recognizes the latest version number based on the response information received in Operation S64.

[Operation S85] The file management unit 320 transmits the update request to all the other frontends of which the status is “Modified” and “Shared.” The file management unit 320 receives the latest version number before the block update as a response corresponding to the update request.

[Operation S86] The file management unit 320 increments the version number to generate a new version number. The file management unit 320 changes the status of the block as an update target into “Modified.”

In Operation S85, the information received as a response corresponding to the update request by the file management unit 320 may not include the version number. In this case, in Operation S86, the file management unit 320 recognizes the latest version number before the update based on the response information received in Operation S64. In Operation S85, the file management unit 320 may transmit the purge request instead of the update request.

[Operation S86] The file management unit 320 appends the new update data received from the application processing unit 310 together with the generated new version number to the internal cache 331. Due to this, the data of the block is updated.

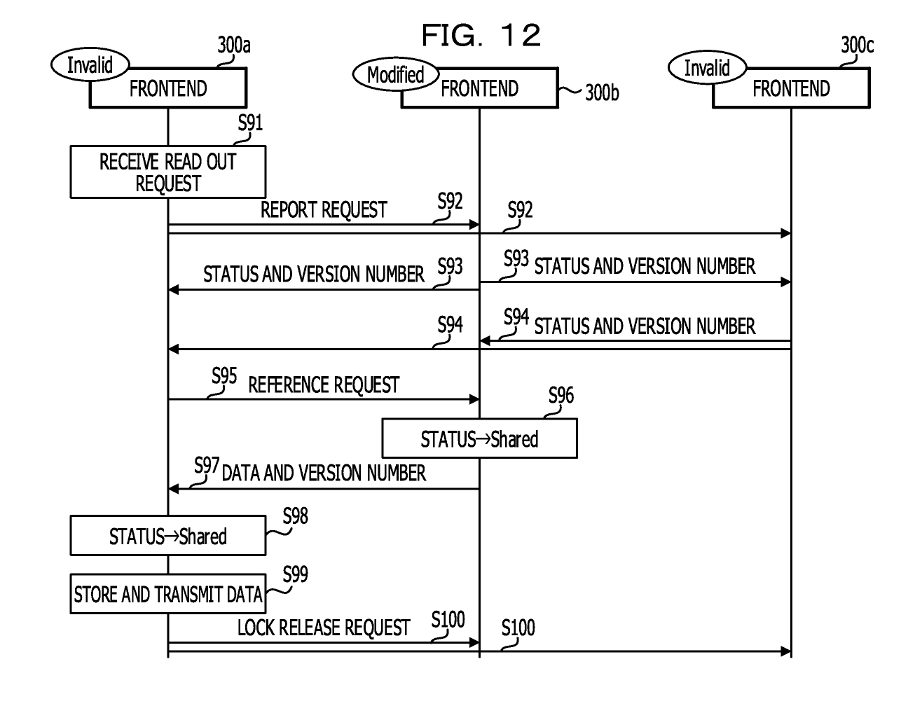

FIG. 12 is a sequence diagram illustrating an example of the processing of a case where the status of the frontend that performs the update is “Invalid.” In FIG. 12, for example, the status of the block as a reference target in the initial state is “Invalid” in the frontends 300a and 300c and “Modified” in the frontend 300b.

[Operation S91] The file management unit 320 of the frontend 300a receives the reference request of the block from the application processing unit 310. [Operation S92] The file management unit 320 of the frontend 300a broadcasts the report request of the status and the version number to the other frontends (corresponding to Operation S63 in FIG. 10).

[Operation S93] The file management unit 320 of the frontend 300b broadcasts the response corresponding to the report request. The “Modified” status and the latest version number of the block at the present moment are set to the response information transmitted from the frontend 300b.

[Operation S94] The file management unit 320 of the frontend 300c broadcasts the response corresponding to the report request. The “Invalid” status is set to the response information transmitted from the frontend 300c. When the frontend 300c holds the data of the old version number regarding the block as a reference target, the latest version number among the version numbers added to the data held by the frontend 300 is set to the response information to be transmitted.

Operations S93 and S94 may be performed in the reverse order or may be performed concurrently. When the normal response information is transmitted from both the frontend 300b and the frontend 300c, the frontends 300b and 300c are in the locked state.

[Operation S95] After receiving the response information, if the file management unit 320 of the frontend 300a determines that no NG response is received, the file management unit 320 transmits the reference request to the frontend 300b of which the status is “Modified” (corresponding to Operation S82 in FIG. 11). The reference request plays a role in requesting for permission of the reference of the target block.

[Operation S96] After receiving the reference request, the file management unit 320 of the frontend 300b appends the latest data and the version number of the block stored in the internal cache 331 to the off-core cache 332. The file management unit 320 of the frontend 300b changes the status of the block from “Modified” into “Shared.”

[Operation S97] The file management unit 320 of the frontend 300b transmits the latest data of the block and the version number added to the block to the frontend 300a. [Operation S98] The file management unit 320 of the frontend 300a changes the status of the block into “Shared” (corresponding to Operation S83 in FIG. 11).

[Operation S99] The file management unit 320 of the frontend 300a appends the received data and version number to the off-core cache 332 and the internal cache 331. The file management unit 320 reads out the data stored in the internal cache 331 into the application processing unit 310 (corresponding to Operation S84 in FIG. 11).

[Operation S100] The file management unit 320 of the frontend 300a broadcasts the lock release request (corresponding to Operation S74 in FIG. 10). In the processing illustrated in FIG. 12, when receiving the reference request, the frontend 300b appends the latest data and the version number stored in the internal cache 331 to the off-core cache 332 instead of the backend 200. When completing the appending to the off-core cache 332, the frontend 300b responds to the frontend 300a.

As described above, when the data is appended to the off-core cache 332 that is assessable at a higher speed as compared with the backend 200, the frontend 300b with the “Modified” status changes the status into “Shared” and transmits the data to the frontend 300a. Due to this, the cache coherency is maintained between the frontend 300a and the frontend 300b, and the time desired by the frontend 300a to reference the data may be shortened.

When the status of the frontend 300b in the initial state is “Shared,” FIG. 12 is deformed as described below. In Operation S93, the frontend 300b broadcasts the response information to which the “Shared” status is set. When the status of the frontend 300b is “Shared,” the latest data of the block is stored in both the internal cache 331 and the off-core cache 332 of the frontend 300b. Therefore, when receiving the reference request from the frontend 300a, the frontend 300b skips the processing of Operation S96 and performs the processing of Operation S97.

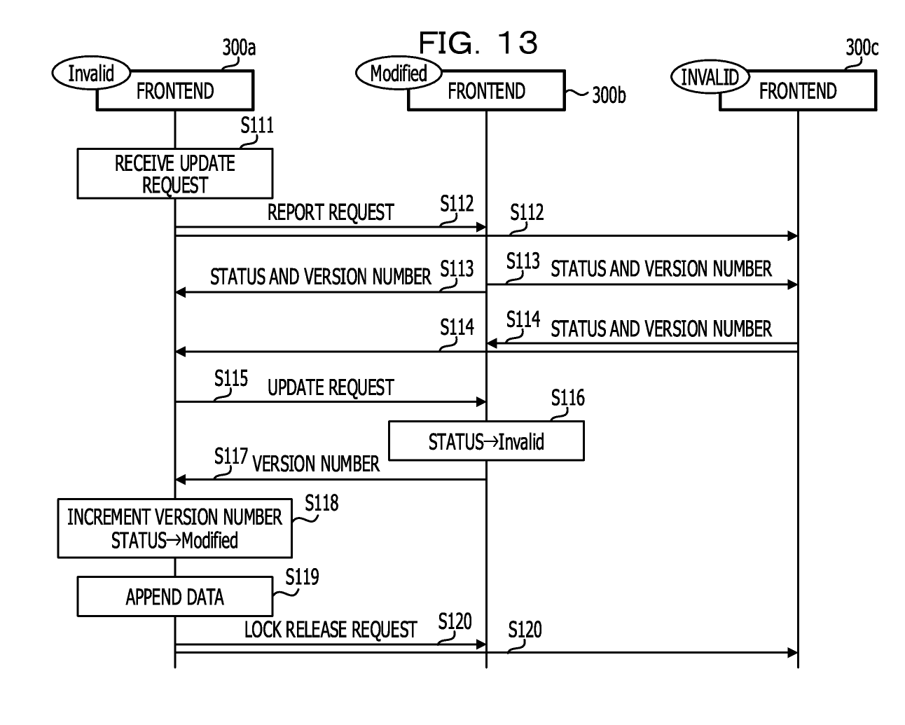

FIG. 13 is a sequence diagram illustrating an example of the processing in a case where the status of the frontend that performs the update is “Invalid.” In FIG. 13, for example, the status of the reference target block in the initial state is “Invalid” in the frontends 300a and 300c and “Modified” in the frontend 300b.

[Operation S111] The file management unit 320 of the frontend 300a receives the update request of the block from the application processing unit 310. [Operation S112] The file management unit 320 of the frontend 300a broadcasts the report request of the status and the version information to the other frontends (corresponding to Operation S63 in FIG. 10).

[Operation S113] The file management unit 320 of the frontend 300b broadcasts the response corresponding to the report request. The “Modified” status and the latest version number of the block at the present moment are set to the response information transmitted from the frontend 300b.

[Operation S114] The file management unit 320 of the frontend 300c broadcasts the response corresponding to the report request. The “Invalid” status and the latest version number from among the version numbers added to the data held by the frontend 300c are set to the response information transmitted from the frontend 300c.

Operations S113 and S114 may be performed in the reverse order or may be performed concurrently. When the normal response information is transmitted from both the frontend 300b and the frontend 300c, the frontends 300b and 300c are in the locked state.

[Operation S115] When receiving the response information, if the file management unit 320 of the frontend 300a determines that no NG response is received, the file management unit 320 transmits the update request to the frontend 300b of which the status is “Modified” (corresponding to Operation S85 in FIG. 11). The reference request plays a role in requesting for permission of the update of the target block.

[Operation S116] After receiving the update request, the file management unit 320 of the frontend 300b appends the latest data and the version number of the block stored in the internal cache 331 to the off-core cache 332. The file management unit 320 of the frontend 300b changes the status of the target block into “Invalid.”

[Operation S117] The file management unit 320 of the frontend 300b transmits the latest version number as a response corresponding to the update request to the frontend 300a. The transmitted response information means that the update of the block with respect to the frontend 300a is permitted.

[Operation S118] The file management unit 320 of the frontend 300a increments the latest version number of the block as an update target to generate a new version number. The file management unit 320 changes the status of the block as an update target into “Modified” (corresponding to Operation S86 in FIG. 11).

[Operation S119] The file management unit 320 of the frontend 300a appends the new update data together with the generated new version to the internal cache 331 (corresponding to Operation S87 in FIG. 11).

After transmitting the update request to the frontend 300b of which the status is “Modified,” the frontend 300a performs the block update processing of Operations S118 and S119. Due to this, the cache coherency may be maintained.

[Operation S120] The file management unit 320 of the frontend 300a broadcasts the lock release request (corresponding to Operation S74 in FIG. 10). In the processing illustrated in FIG. 13, when receiving the update request, the frontend 300b appends the latest data and the version number stored in the internal cache 331 to the off-core cache 332 instead of the backend 200. After completing the appending to the off-core cache 332, the frontend 300b responds to the frontend 300a to permit the update of the block.

In this manner, when the data is appended to the off-core cache 332 that is accessible at a higher speed as compared with the backend 200, the frontend 300b of which the status is “Modified” permits the frontend 300a to update the block. As a result, the cache coherency is maintained between the frontend 300a and the frontend 300b, and the time before the frontend 300a updates the data may be shortened.

When the status of the frontend 300b in the initial state is “Shared,” FIG. 13 is deformed as described below. In Operation S113, the frontend 300b broadcasts the response information to which the “Shared” status is set. When the status of the frontend 300b is “Shared,” the latest data of the block is stored in both the internal cache 331 and the off-core cache 332 of the frontend 300b. Therefore, in Operation S116, the frontend 300b skips the processing for appending the latest data to the off-core cache 332.

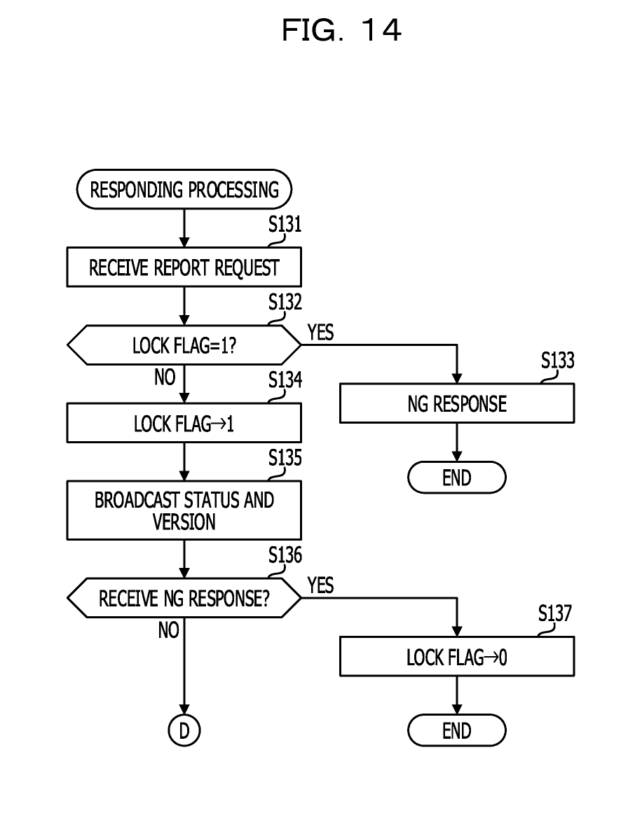

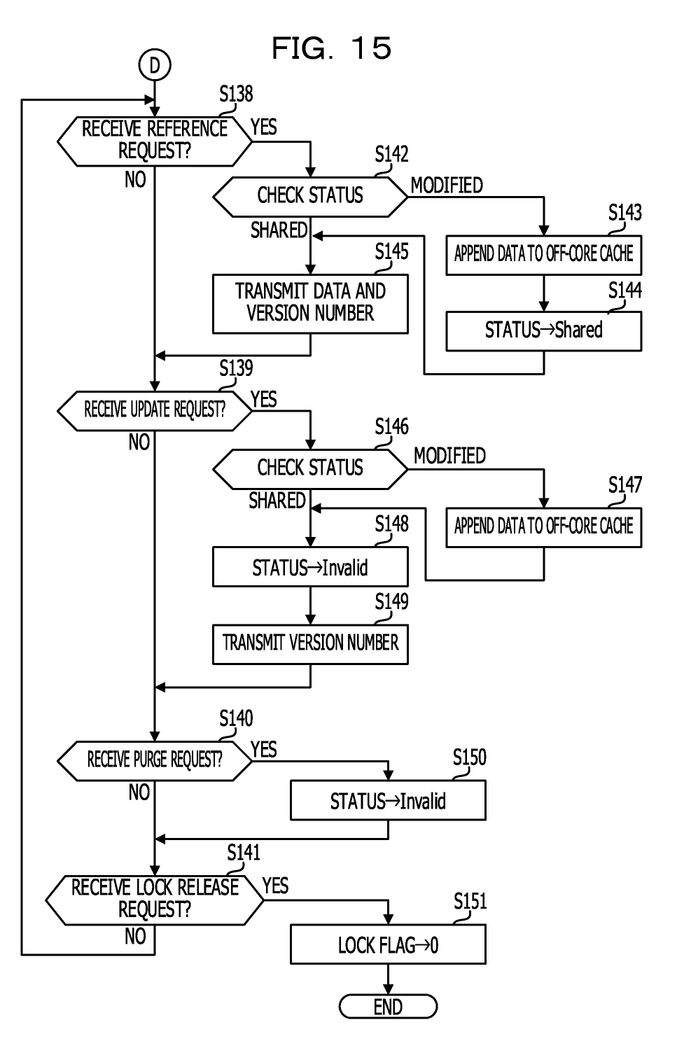

FIGS. 14 and 15 are flowcharts illustrating an example of a responding processing procedure by a file management unit. For example, processing of the file management unit 320 included in the frontend 300a will be described below.

[Operation S131] When receiving the report request broadcasted from the other frontends, the file management unit 320 of the frontend 300a performs the processing following Operation S132. The inode number and the block number that identify the processing target block are set to the received report request.

[Operation S132] If the lock flag of the target block is “1,” the file management unit 320 performs the processing of Operation S133. If the lock flag is “0,” the file management unit 320 performs the processing of Operation S134.

[Operation S133] The file management unit 320 broadcasts the NG response information and ends the processing. [Operation S134] The file management unit 320 changes the lock flag into “1.”

[Operation S135] The file management unit 320 broadcasts the response information to which the status of the target block in the frontend 300a and the version number of the latest data of the block held by the frontend 300a are set.

[Operation S136] After receiving the broadcasted communication request, when the other frontends broadcast the response information, the frontend 300a receives the response information. If there is NG response information in the received response information, the file management unit 320 performs the processing of Operation S137. If there is no NG response information in the received response information, the file management unit 320 performs the processing of Operation S138 illustrated in FIG. 15.

The file management unit 320 may receive the response information from the other frontend during the period starting from Operation S131 to Operation S135. When the file management unit 320 receives the NG response information during the period starting from Operation S131 to Operation S135, the file management unit 320 starts the processing of Operation S137.

[Operation S137] The file management unit 320 determines that the target block is in the locked state in the other frontends and sets the lock flag to “0.” If the lock flag is already set to “0,” the value is maintained.

As described above, when receiving the normal response information from all the frontends of the transmission destinations, the frontend that transmitted the report request determines that the lock is achieved. Each of the frontends that receives the report request monitors the response information replied from the other frontends. If there is no NG response information in the response information, the lock flag is “1.” When the lock flag is “1,” the frontend is transferred to the state where the processing request regarding the target block from the frontend other than the frontend of the transmission source of the report request is not received.

If the NG response information is included in the replied response information, each frontend determines that the authorization of reference and update is not given to the frontend of the transmission destination of the report request and then forcibly ends the processing.

As described above, by determining whether the locked state is set based on the response information corresponding to the broadcasted report request, the exclusion control of the reference or the update may be easily performed. [Operation S138] The file management unit 320 determines whether the reference request is received from the frontend that transmitted the report request. If the reference request is received within a prescribed period of time, the file management unit 320 performs the processing of Operation S142. If the reference request is not received within the prescribed period of time, the file management unit 320 performs the processing of Operation S139.

[Operation S139] The file management unit 320 determines whether the update request is received from the frontend that transmitted the report request. If the update request is received within the prescribed period of time, the file management unit 320 performs the processing of Operation S146. If the update reference is not received within the prescribed period of time, the file management unit 320 performs the processing of Operation S140.

[Operation S140] The file management unit 320 determines whether the purge request is received from the frontend that transmits the report request. If the purge request is received within the prescribed period of time, the file management unit 320 performs the processing of Operation S150. If the purge request is not received within the prescribed period of time, the file management unit 320 performs the processing of Operation S141.

[Operation S141] The file management unit 320 determines whether the lock release request is received from the frontend that transmits the report request. If the lock release request is received within the prescribed period of time, the file management unit 320 performs the processing of Operation S151. If the lock release request is not received within the prescribed period of time, the file management unit 320 performs the processing of Operation S138.

Therefore, the file management unit 320 repeats the determining processing starting from Operation S138 to Operation s141 at fixed time intervals. [Operation S142] When receiving the reference request, the file management unit 320 checks the status of the target block. If the status is “Modified,” the file management unit 320 performs the processing of Operation S143. If the status is “Shared,” the file management unit 320 performs the processing of Operation S145.

[Operation S143] The file management unit 320 appends the latest data and the version number of the block stored in the internal cache 331 to the off-core cache 332.

[Operation S144] The file management unit 320 changes the status of the target block into “Shared.” [Operation S145] The file management unit 320 reads out the latest data and the version number of the block from the internal cache 331 and then transmits the response information to which the read-out data is set to the frontend of the transmission source of the reference request.

[Operation S146] When receiving the update request, the file management unit 320 checks the status of the target block. If the status is “Modified,” the file management unit 320 performs the processing of Operation S147. If the status is “Shared,” the file management unit 320 performs the processing of Operation S148.

[Operation S147] The file management unit 320 appends the latest data and the version number of the block stored in the internal cache 331 to the off-core cache 332.

[Operation S148] The file management unit 320 changes the status of the target block into “Invalid.” [Operation S149] The file management unit 320 sets the version number added to the latest data of the block to the response information and then transmits the response information to the frontend of the transmission source of the reference request.

[Operation S150] When receiving the purge request, the file management unit 320 changes the status of the target block into “Invalid.” [Operation S151] When receiving the lock release request, the file management unit 320 changes the lock flag associated with the target block into “0” and ends the processing.

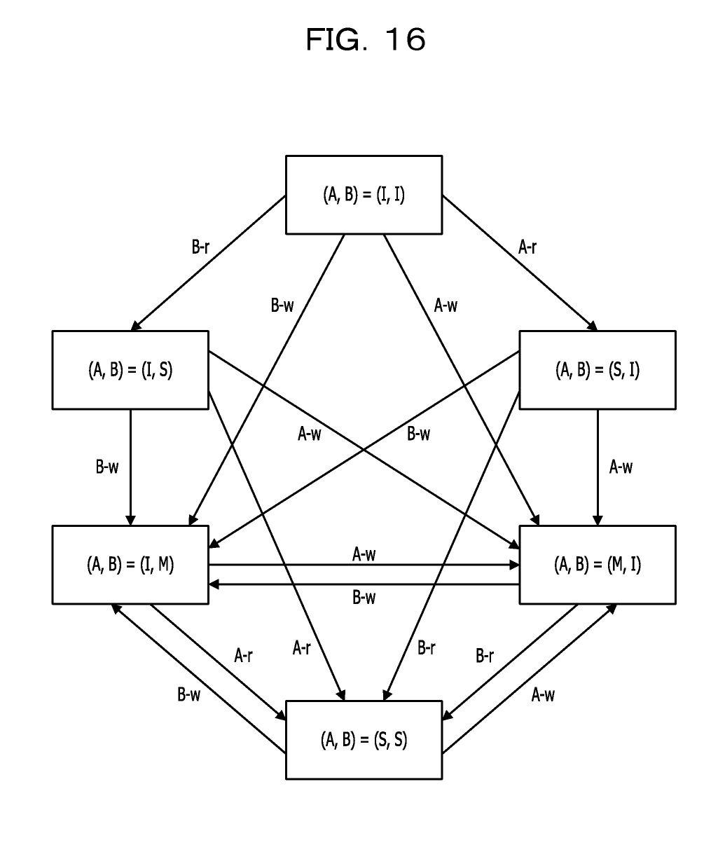

FIG. 16 is a diagram illustrating an example of transition of the status. For example, FIG. 16 illustrates ways of changing of the status of the frontend A and the frontend B when the reference or the update of the block occurs in the frontend A and the frontend B.

In FIG. 16, “M” indicates “Modified,” “S” indicates “Shared,” and “I” indicates “Invalid.” For example, “(A, B)=(I, S)” indicates that the status of the frontend A is “Invalid” and the status of the frontend B is “Shared.” Further, “A-r” indicates that the block is referenced in the frontend A, and “A-w” indicates that the block is updated in the frontend A.

If (A,B)=(I,I) when the block is referenced in the frontend A, the transition of the status is made to (A,B)=(S,I). If (A,B)=(I,I) when the block is referenced in the frontend B, the transition of the status is made to (A,B)=(I,S). If (A,B)=(I,I) when the block is updated in the frontend A, the transition of the status is made to (A,B)=(M,I). If (A,B)=(I,I) when the block is updated in the frontend B, the transition of the status is made to (A,B)=(I, M).

If (A,B)=(I,S) when the block is referenced in the frontend A, the transition of the status is made to (A,B)=(S,S). If (A,B)=(I,S) when the block is updated in the frontend A, the transition of the status is made to (A,B)=(M,I). If (A,B)=(I,S) when the block is updated in the frontend B, the transition of the status is made to (A,B)=(I,M). If (A,B)=(I,S) when the block is referenced in the frontend B, the status does not change.

If (A,B)=(S,I) when the block is referenced in the frontend B, the transition of the status is made to (A,B)=(S,S). If (A,B)=(S,I) when the block is updated in the frontend B, the transition of the status is made to (A,B)=(I,M). If (A,B)=(S,I) when the block is referenced in the frontend A, the transition of the status is made to (A,B)=(M,I). If (A,B)=(S,I) when the block is referenced in the frontend A, the status does not change.

If (A,B)=(I,M) when the block is referenced in the frontend A, the transition of the status is made to (A,B)=(S,S). If (A,B)=(I,M) when the block is updated in the frontend A, the transition of the status is made to (A,B)=(M,I). If (A,B)=(I, M) when the block is referenced in the frontend B, the status does not change.

If (A,B)=(M, I) when the block is referenced in the frontend B, the transition of the status is made to (A,B)=(S,S). If (A,B)=(M,I) when the block is updated in the frontend B, the transition of the status is made to (A,B)=(I,M). If (A,B)=(M,I) when the block is referenced in the frontend A or updated in the frontend A, the status does not change.

If (A,B)=(S,S) when the block is updated in the frontend A, the transition of the status is made to (A,B)=(M,I). If (A,B)=(S,S) when the block is updated in the frontend B, the transition of the status is made to (A,B)=(I,M). If (A,B)=(S,I) when the block is referenced in the frontend A or the frontend B, the status does not change.

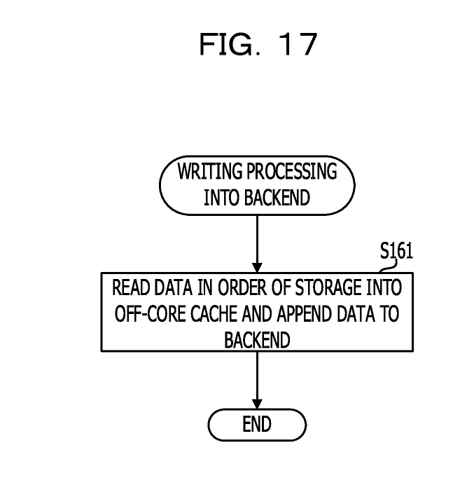

When the status changes as described above, the cache coherency is maintained between the frontend A and the frontend B. FIG. 17 is a flowchart illustrating an example of writing processing from the off-core cache into the backend. The file management unit 320 of each frontend performs the processing of Operation S161 at a timing that is not synchronized with the appending timing of the data and the version number into the off-core cache 332.

[Operation S161] The file management unit 320 reads out the data and the version number stored in the off-core cache 332 in an order of the storage regardless of the block and then appends the read-out data and version to the backend 200. The storage area of the data and the version number in the backend 200 is determined by a method that is determined by the log-structured file system.

In the above-described procedure, the data and the version number stored in the off-core cache of each frontend are stored in the backend 200. The writing speed of the data with respect to the backend 200 may be considerably lower than the writing speed of the data with respect to the off-core cache 332. However, each frontend does not directly store the data and the version number stored in the internal cache 331 in the backend 200. Each frontend stores the data and the version number in the off-core cache 332. As a result, the writing speed of the data with respect to the backend 200 does not affect the speed of the update or the reference of the data of the block in each frontend. Therefore, performance of the update or the reference of the data in each frontend may be improved.

The off-core cache 332 is a non-volatile storage area that is similar to the storage area of the backend 200. Therefore, a probability of losing the data and the version number of the block due to an occurrence of a trouble is low as with a case where the data and the version number stored in the internal cache 331 is directly stored in the backend 200.

Below is a description of the data recovering processing in a case where the frontend abnormally stops. When the frontend abnormally stops, the information stored in the internal cache 331 of the frontend that abnormally stops is lost. After the frontend that abnormally stopped restarts, the data of the cache is recovered based on the information stored in the off-core cache 332 of each frontend.

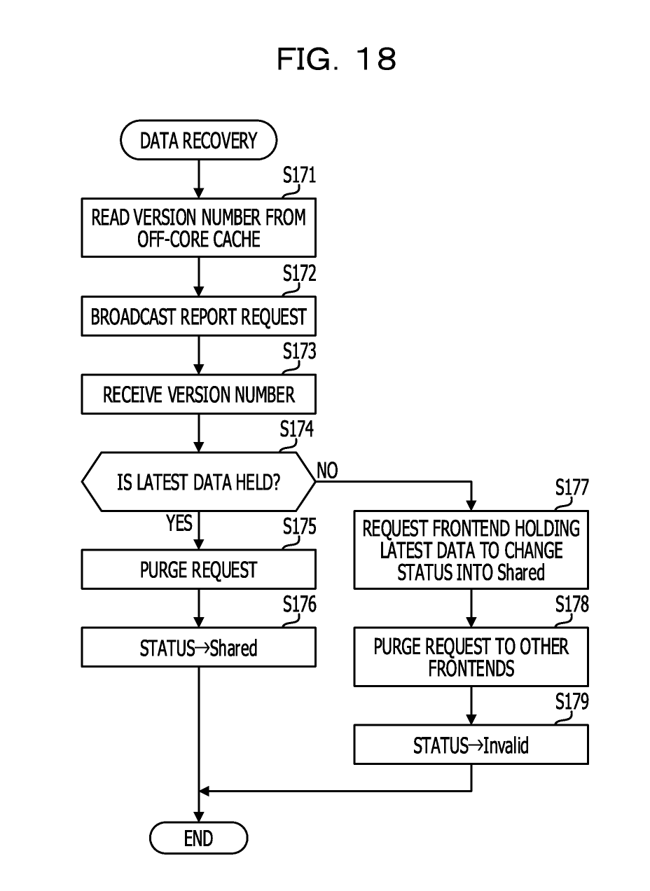

FIG. 18 is a flowchart illustrating an example of the data recovering processing procedure by the file management unit of a representative server. One of the frontends included in the storage system 100 is previously determined to be the representative server that controls the data recovery when the frontend abnormally stops. When at least one frontend in the storage system 100 abnormally stops, the frontend as the representative server performs the processing illustrated in FIG. 18 after the frontend that abnormally stopped restarts. FIG. 18 illustrates, for example, the processing for one block. Actually, the processing illustrated in FIG. 18 is performed for all the blocks.

[Operation S171] The file management unit 320 reads the version number of the block from the off-core cache 332 to determine the latest version number. Similarly, the file management unit 320 of each of the frontends other than the representative server reads the version number of the block from the off-core cache 332 to determine the latest version number. After determining the latest version number, the file management unit 320 of each of the frontends other than the representative server monitors the report request.

[Operation S172] The file management unit 320 broadcasts the report request. [Operation S173] The file management unit 320 receives the response information corresponding to the report request from the other frontend and recognizes the version number of the latest data held by each of the other frontends.

[Operation S174] The file management unit 320 determines whether the frontend corresponding to the file management unit 320 holds the latest data based on the latest version number determined in Operation S171 and on the version number received from another client in Operation S173. When the frontend corresponding to the file management unit 320 holds the latest data, the file management unit 320 performs the processing of Operation S175. If the frontend corresponding to the file management unit 320 does not hold the latest data, the file management unit 320 performs the processing of Operation S177.

[Operation S175] The file management unit 320 transmits the purge request to all the other frontends to set the status of the target block in the frontend of the transmission destination to “Invalid.”

[Operation S176] The file management unit 320 stores the latest data and the version number stored in the off-core cache 332 of the frontend corresponding to the file management unit 320 in the internal cache 331 and also sets the status of the target block to “Shared.” Due to this, the data recovering processing is completed, and the operation of the storage system 100 is restarted.

[Operation S177] The file management unit 320 requests the frontend that holds the latest data to change the status of the target block into “Shared.” [Operation S178] The file management unit 320 transmits the purge request to the frontend that does not hold the latest data among the other frontends to set the status of the target block in the frontend of the transmission destination to “Invalid.”

[Operation S179] The file management unit 320 sets the status of the target block of the frontend corresponding to the file management unit 320 to “Invalid.” Due to this, the data recovering processing is completed, and the operation of the storage system 100 is restarted.

According to the processing illustrated in FIG. 18, the representative server does not rewrite the data and the version number from the backend 200 and may recover the data of the cache based on the data and the version information stored in the off-core cache of each frontend. Therefore, the operation of the storage system 100 may be restarted in a short time.

The processing functions of the access control device, the frontend, the data storage server, and the client illustrated in the embodiments may be achieved by a computer. In this case, when a program in which the processing contents of the functions included in each device is provided and executed by the computer, the above-described functions are achieved on the computer. The program in which the processing contents are written may be recorded in a computer-readable recording medium. The computer-readable recording medium is, for example, a magnetic storage device, an optical disk, an optical magnetic recording medium, a semiconductor memory, or the like. The magnetic storage device is, for example, a Hard Disk Device (HDD), a flexible disk (FD), a magnetic tape, or the like. The optical disk is, for example, a DVD, a DVD-RAM, a CD-ROM, a CD-R/RW, or the like. The optical magnetic recording medium is, for example, a Magneto-Optical disk (MO) or the like.

To distribute the program, for example, a portable recording medium such as a DVD and a CD-ROM in which the program is recorded is sold. The program may be stored in a storage device in a server computer and then may be transferred from the server computer to another computer through a network.

The computer that executes the program stores, in the storage device thereof, for example, the program recorded in a portable recording medium or the program transferred from the server computer. The computer reads out the program from the storage device thereof and then performs the processing according to the program. The computer may read out the program directly from the portable recording medium and perform the processing according to the program. The computer may perform the processing according to the received program every time the program is transferred from the server computer coupled through the network.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A storage system comprising:
a storage that stores a file; and
a plurality of access control devices that control access to the storage and include a cache memory in which the file to be stored in the storage is stored in blocks, wherein when receiving an update request of a prescribed block and latest data of the prescribed block is not stored in the cache memory of a first access control device, the first access control device among the plurality of access control devices obtains a version number added to the latest data from a second access control device, in which the latest data is stored in the cache memory thereof, among the plurality of access control devices, and
wherein the first access control device stores update data that updates the prescribed block in the cache memory of the first access control device and adds a new version number to the update data based on the version number.

2. The storage system according to claim 1, wherein the second access control device reports the version number added to the latest data to the first access control device and permits the first access control device to update the prescribed block after appending the latest data together with the version number to a prescribed non-volatile memory.

3. The storage system according to claim 2, wherein
each of the plurality of access control devices includes a local memory,
wherein the second access control device reports the version number added to the latest data to the first access control device and permits the first access control device to update the prescribed block after appending the latest data and the version number of the latest data to the local memory included in the second access control device, and
wherein the second access control device appends the latest data appended to the local memory to the storage at a timing that is not synchronized with the timing of appending the latest data and the version number of the latest data to the local memory.

4. The storage system according to claim 3, wherein when one of the plurality of access control devices abnormally stops, after the access control device that abnormally stops is recovered, a prescribed access control device among the plurality of access control devices stores the data, which is associated with a latest version number based on the version number of each block stored in the local memory of all the access control devices, together with the version number in the cache memory and the local memory of the prescribed access control device to restart an operation of the storage system.

5. The storage system according to claim 3, wherein after transmitting the version number added to the latest data according to a report request from the first access control device to the first access control device, when the second access control device receives a permission request for requesting permission of data update from the first access control device, the second access control device appends the latest data and the version number of the latest data to the local memory included in the second access control device and then transmits a response to permit the data update in response to the received permission request.

6. The storage system according to claim 2, wherein the first access control device broadcasts a report request for reporting a piece of status information indicating whether the latest data of the prescribed block is stored in the cache memory and the version number added to the data of the prescribed block stored in the cache memory, and
wherein based on the status information replied in response to the report request, the first access control device determines the access control device in which the latest data is stored in the cache memory thereof and determines a new version number to be added to the update data based on the version number replied in response to the report request.

7. The storage system according to claim 6, wherein when receiving the report request, each of the access control devices broadcasts the response information in response to the report request, and
wherein when a normal response is output from all the access control devices that receive the report request to the first access control device, the data update and the data reference regarding the prescribed block are prohibited in all the access control devices except the first access control device.

8. A computer-readable recording medium storing a program causing a processor in a computer to execute an operation, the operation comprising:
when receiving an update request of a prescribed block and latest data of the prescribed block is not stored in a cache memory of the computer where a file to be stored in a storage is stored in blocks, obtaining a version number added to the latest data from another computer in which the latest data is stored in the cache memory thereof among a plurality of computers having the cache memory respectively;
storing the update data that updates the prescribed block in the cache memory of the computer; and
adding a new version number to the update data based on the version number.

9. The computer-readable recording medium according to claim 8, wherein the operation further comprising:
when one of the plurality of computers receives the update request of the prescribed block and when the latest data of the prescribed block is stored in the cache memory of the computer, reporting the version number added to the latest data to the other computer that receives the update request; and
after appending the latest data together with the version number to a prescribed non-volatile storage device, permitting the other computer that receives the update request to update the prescribed block.

10. The computer-readable recording medium according to claim 9, wherein the computer and the plurality of other computers include a non-volatile local memory, respectively,
wherein the processing for permitting the other computer that receives the update request to update the prescribed block, the processing comprising:
reporting the version number added to the latest data to the other computer that receives the update request;
appending the latest data and the version number of the latest data to the local memory of the computer; and
permitting the other computer that receives the update request to update the prescribed block, and
wherein the operation further comprising:
appending the latest data appended to the local memory to the storage at a timing that is not synchronized with the timing of appending the latest data and the version number of the latest data to the local memory of the computer.

11. The computer-readable recording medium according to claim 10, wherein the operation further comprising:
when one of the plurality of other computers abnormally stops, after the other computer that abnormally stops is recovered, based on the version number of each block stored in the local memory of each of the computer and the plurality of other computers, storing the data associated with the latest version number together with the version number in the cache memory and the local memory of the computer; and
restarting the operation of the storage system that includes the computer and the plurality of other computers.

12. The computer-readable recording medium according to claim 10, wherein the processing for permitting the other computer that receives the update request to update the prescribed block, the processing comprising:
replying the version number added to the latest data in response to the report request from the other computer that receives the update request;
when receiving the permission request for permitting the data update from the other computer that receives the update request, appending the latest data and the version number of the latest data to the local memory of the computer; and
transmitting a response for permitting the data update in response to the received permission request.

13. The computer-readable recording medium according to claim 9, wherein the operation further comprising:
broadcasting a report request for reporting a piece of status information, which indicates whether the latest data of the prescribed block is stored in the cache memory, and the version number added to the data of the prescribed block stored in the cache memory, wherein the processing of the computer for adding the new version number, comprising:
based on the status information replied in response to the report request, determining the other computer in which the latest data is stored in the cache memory thereof; and
based on the version number replied in response to the report request, determining the new version number to be added to the update data.

14. The computer-readable recording medium according to claim 13, wherein the operation further comprising:
when receiving the report request broadcasted from one of the plurality of other computers, broadcasting a piece of response information corresponding to the report request; and
when a normal response is output from all the other computers that receive the report request, prohibiting data update and data reference regarding the prescribed block in the computer.

15. A cache control method executed by a storage system that includes a storage that stores a file and a plurality of access control devices that controls access to the storage and includes a cache memory in which the file to be stored in the storage is stored in blocks, comprising:
when a first access control device among the plurality of access control devices receives an update request of a prescribed block and latest data of the prescribed block is not stored in the cache memory of the first access control device, obtaining a version number added to the latest data from a second access control device, among the plurality of access control devices, in which the latest data is stored in the cache memory thereof; and
storing update data that updates the prescribed block in the cache memory of the first access control device and adding a new version number to the update data based on the version number.

16. The cache control method according to claim 15, wherein the second access control device reports the version number added to the latest data to the first access control device and appends the latest data together with the version number to a prescribed non-volatile storage device, and
wherein the second access control device permits the first access control device to update the prescribed block.

17. The cache control method according to claim 16, wherein the plurality of access control devices includes the non-volatile local memory, respectively,
wherein the processing of the second access control device for permitting the first access control device to update, the processing comprising:
reporting the version number added to the latest data to the first access control device;
appending the latest data and the version number of the latest data to the local memory included in the second access control device;
permitting the first access control device to update the prescribed block; and
appending the latest data appended to the local memory at a timing that is not synchronized with the timing when the second access control device appends the latest data and the version number of the latest data to the local memory.

18. The cache control method according to claim 17, wherein the method further comprising:
when one of the plurality of access control devices abnormally stops, after the access control device that abnormally stops is recovered, based on the version number of each block stored in the local memory of all the access control devices, a prescribed access control device among the plurality of access control devices stores the data associated with the latest version number together with the version number in the cache memory and the local memory of the prescribed access control device and then restarts the operation of the storage system.

19. The cache control method according to claim 17, wherein the processing of the second access control device for permitting the first access control device to update the data, the processing comprising:
transmitting the version number added to the latest data in response to the report request from the first access control device to the first access control device;
when receiving the permission request for permitting the data update from the first access control device, appending the latest data and the version number of the latest data to the local memory included in the second access control device; and
transmitting the response for permitting the data update in response to the received permission request.

20. The cache control method according to claim 16, wherein the method further comprising:
the first access control device broadcasts the report request for reporting the status information indicating whether the latest data of the prescribed block is stored in the cache memory and the version number added to the data of the prescribed block stored in the cache memory,
wherein the processing of the first access control device for adding the new version number, comprising:
based on the status information replied in response to the report request, determining the access control device in which the latest data is stored in the cache memory thereof; and
based on the version number replied in response to the report request, determining the new version number added to the update data.
